(19) United States
(12) Patent Application Publication
(10) Pub. No.: US 2008/0077261 A1
(43) Pub. Date: Mar. 27, 2008

(54) METHOD AND SYSTEM FOR SHARING AN AUDIO EXPERIENCE

(75) Inventors: DANIEL A. BAUDINO, LAKE WORTH, FL (US); DEEPAK P. AHYA, PLANTATION, FL (US); JOHN M. BURGAN, NORTH PALM BEACH, FL (US); MONIKA R. WOLF, PARKLAND, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/468,057

(22) Filed: Aug. 29, 2006

(51) Int. Cl. G06F 17/00

(52) U.S. Cl. 700/94

(57) ABSTRACT

A system (100) and method (400) for sharing an audio experience is provided. The method can include identifying (402) mobile devices (104) in an area (910), discovering (404) sound production capabilities and sound monitoring capabilities, identifying (406) a relative location of devices in the area, assessing room acoustics (706), and networking the (408) devices for creating a surround sound based on the relative location, sound capabilities, and room acoustics. The system can include a group of active devices to generate the surround sound, a group of passive devices to listen to the surround sound, and a master device to configure the delivery of audio media based on the surround sound analyzed by the passive devices

### FIELD OF THE INVENTION

This invention relates generally to mobile communication systems, and more particularly to sound production.

### BACKGROUND OF THE INVENTION

The mobile device industry is constantly challenged in the market place for high tier products having unique features. For example, demand for mobile devices which play music has dramatically risen. Today music portable devices are very popular, and there are multiple type of devices supporting music playback such as MP3 Players, cell phones, and satellite radio systems. These devices are capable of reproducing music stored or downloaded to the device. Users can download different songs or music clips and listen to the music played by the device. For example, the device may individually support stereo rendering of sound. Consequently, when using headsets or earphones, the user can be immersed in the music experience. However, in non-headset or non-earphone mode, such devices are generally incapable of generating a true stereo experience. Due to the small size of the device and the few number of available speakers, the device is generally limited to mono sound. Also, in some cases, more than one user may want to listen to music together. Accordingly, sharing the music experience with more than one user, without a headset or earphones, does not provide a stereo rendering of the music. A need therefore exists for providing stereo sound for sharing a music experience with multiple users.

### SUMMARY OF THE INVENTION

Broadly stated, embodiments of the invention are directed to a method and system for generating a surround sound to provide a shared audio experience. The method can include networking a plurality of devices that are in proximity of one another, identifying a relative location of the plurality of devices in the proximity, configuring a delivery of audio media to the plurality of devices based on the relative location, and generating a surround sound from the plurality of devices in accordance with the delivery of audio. Each of the device can contribute a portion of audio to provide a surround experience. One of the devices can be designated as a master device that assigns a first group of devices as active devices for generating the surround sound, and a second group of devices as passive devices for listening to the surround sound. The master device can configure the delivery of audio media to the active devices based on the surround sound analyzed by the passive devices.

In one arrangement, the master device can discover sound capabilities for the plurality of devices, such as an audio bandwidth, a data processing capacity, a battery capacity, or a speaker volume level. The master device can assign audio channels to active devices based on the sound capability and the relative location. Devices can be added or removed in response to a device entering or leaving the proximity. In one aspect, the passive devices can listen to the surround sound, and identify audio nulls in the surround sound at a location. The passive devices can report a location of the audio nulls to the master device which can convert the passive device to an active device for playing sound and filling in the audio nulls at the location. In another aspect, the passive devices can identify audio redundancy in the surround sound at a location, and report the audio redundancy to the master device. The master device can convert an active device to a passive device for suppressing audio redundancy at the location.

The method can further include assessing room acoustics of the room from the plurality of devices, selecting devices to generate sound based on sound capabilities of the devices, and formatting the audio media for delivery to the plurality of devices based on the sound capabilities and room acoustics. For instance, the master device can identify a position of active devices in the room, assign audio channels to the active devices based on the position, monitor the active devices contributing to the surround sound, and assign and update audio channels in accordance with sound capabilities of the active devices for maintaining a quality of the surround sound. A quality of the surround can include true stereo rendering, three-dimensional audio rendering, volume balancing, and equalization. In another arrangement, the sound experience can be synchronized with another plurality of devices in another area for sharing the music experience.

In one arrangement, the passive devices can analyze the surround sound by evaluating a volume level of the surround sound, and reporting the volume level to the master device. The master device can equalize the volume level across the plurality of devices, such that a volume of the surround sound is balanced in accordance with a specification of the audio media. In another arrangement, the passive devices can analyze the surround sound by evaluating a stereo distribution of the surround sound, and reporting the stereo distribution to the master device. The master device can equalize the stereo distribution across the plurality of devices, such that a stereo effect of the surround sound is distributed in accordance with a specification of the audio media.

Embodiments of the invention are also directed to a system for mobile disc jockey (DJ). The system can network a plurality of devices in an area, such as a room, for generating a surround sound to provide a shared music experience. The system can include a plurality of devices for generating and monitoring a surround sound in the area, and a master device for assigning devices as active devices or passive devices based on a relative location of the devices, a sound capability of the devices, and a feedback quality of the surround sound. In one arrangement, a master devices can synchronize a delivery of audio with a second master device for sharing the audio experience at more than two locations.

### BRIEF DESCRIPTION OF THE DRAWINGS

FIG. 1 is an illustration of a shared audio experience in accordance with the embodiments of the invention;

FIG. 2 is a mobile device for contributing to a shared audio experience in accordance with the embodiments of the invention;

FIG. 3 is a mobile communication system in accordance with the embodiments of the invention;

FIG. 4 is method for sharing an audio experience in accordance with the embodiments of the invention;

FIG. 5 is a pictorial for describing the method of FIG. 4 in accordance with the embodiments of the invention;

FIG. 6 is a method for assessing sound quality in accordance with the embodiments of the invention;

FIG. 7 is a method for configuring a delivery of audio in accordance with the embodiments of the invention;

FIG. 8 is a a pictorial for describing the method of FIG. 7 in accordance with the embodiments of the invention; and

FIG. 9 is an illustration for synchronizing a shared audio experience in accordance with the embodiments of the invention.

### DETAILED DESCRIPTION OF THE DRAWINGS

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions.

The term “surround sound” can be defined as sound emanating from multiple directions in a controlled manner for emulating a stereophonic sound system having multiple speakers placed around a listening area to enhance an effect of audio. The term “rendering audio” can be defined as arranging a composition and production of audio. The term “proximity” can be defined as a measure of distance, or a location. The term “relative location” can be defined as a location of an object in relation to another object. The term “area” can be defined as a place of location. The term “discovering” can be defined as querying. The term “sound capabilities” can be defined as a capacity for producing sound such as a power level, a battery capacity, an audio bandwidth, a speaker level or direction, a mobility, or a production capacity. The term “active device” can be defined as a device producing sound. The term “passive device” can be defined as a device listening to sound. The term “audio channel” can be defined as a source for producing audio. The term “quality of sound” can be defined as one attribute of sound, such as a reproduction quality, a volume level, an equalization level, a balance, a distortion, or a pan. The term “feedback quality” can be defined as a quality of sound reported to another device. The term “audio experience” can be defined as a totality of audio events perceived through human auditory senses. The term “room acoustics” can be defined as a total effect of sound, especially as produced in an enclosed space

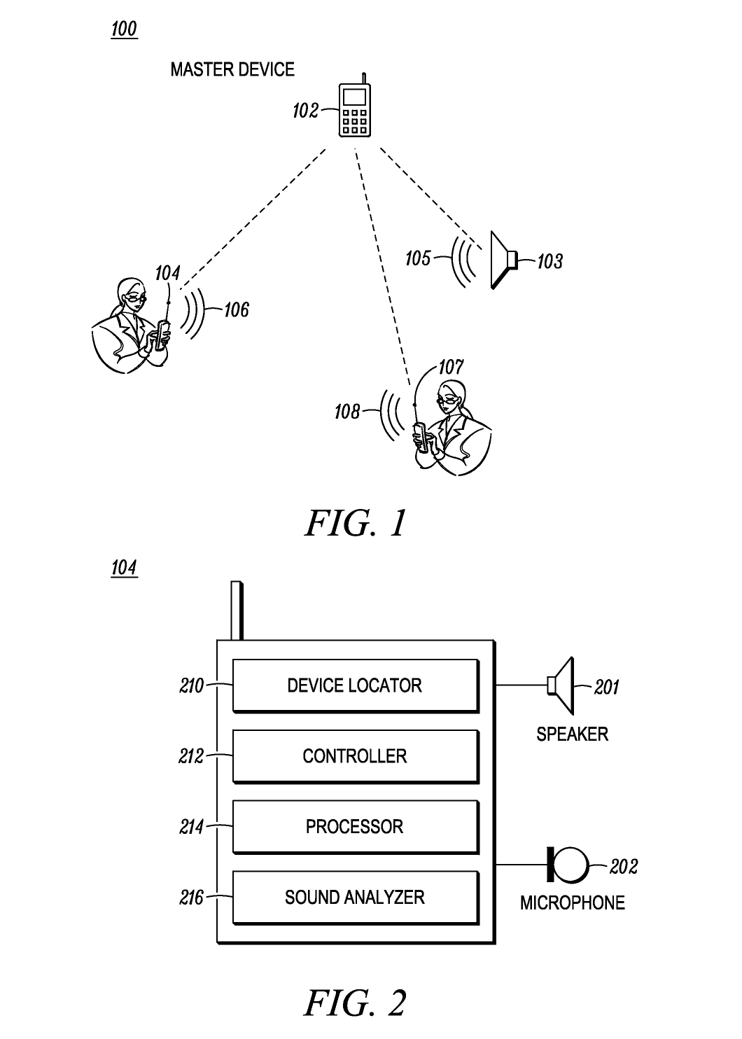

Referring to FIG. 1, a system 100 for sharing an audio experience is shown. The system can include a master device 102, and a plurality of slave devices. The slave devices can include at least one mobile device 104, and optionally include one or more non-mobile devices 103. The master device 102 and the mobile devices 104 may be a cell phone, a portable media player, a music player, a handheld game device, or any other suitable communication device. Moreover, the master device 102 and the mobile device 104 can perform interchangeable functions. That is, a mobile device 104 may operate as a master device 102, and the master device 102 may operate as a mobile device 104.

The master device 102 can be a mobile device 104 that assumes responsibilities for networking the plurality of mobile devices in the area, and coordinates a delivery of audio to generate the shared music experience. A non-mobile device 103 may be a sub-woofer, a home speaker, a home audio system, a television, a radio, or any other audio producing or rendering device. The system 100 is also not limited to the number of components shown. For example, the system 100 may include more or less than the number of mobile devices 104 or non-mobile devices 103 shown.

Briefly, the master device 102 is responsible for coordinating a delivery of audio to the slave devices (e.g. mobile devices 104 and the non-mobile devices 103) based on a relative location of the devices. In particular, the devices 102, 103, 104, and 107 can be networked together in an area, such as a room, to emulate a live concert experience. It should be noted that all the devices 102, 103 and 104 can receive audio media and play at least one portion of an audio media based on a relative location. The slave devices may each download a portion of audio from a network, or the master device 102 can stream audio data to the devices. For example, a first mobile device 104 can play audio 106 corresponding to a left audio channel, a second audio device 107 can play audio 108 corresponding to a right audio channel, and the non-mobile device 103 can play audio 105 corresponding to a sub-woofer for rendering an audio experience.

In one arrangement, the master device 102 can assign different audio channels to the devices based on a relative location of the devices. For example, the master device 102 can assign mobile devices positioned on the left side to play audio corresponding to a left channel, and mobile devices positioned on the right side to play audio corresponding to a right channel. In yet another arrangement, the devices 102, 103, and 104 can assess the acoustics of a room, or an environment, and report the acoustics to the master device 102. The master device 102 can assign audio channels to devices based on their location and sound capabilities in view of the room acoustics. For example, there may be devices located at positions in the room which can amplify or attenuate certain portions of sound due to the room acoustics. The master device 102 can assign some of the devices as active devices for generating audio, and some of the devices for listening to the generated audio. An active device, a passive device, and the master device perform interchangeable functions, such that an active device or passive can be configured as a active device or passive device and that can also be configured as a master device.

Referring to FIG. 2, a block diagram of a mobile device 104 is shown. Notably, the mobile device 104 can also function as a master device 102 (See FIG. 1). The mobile device 104 can include a device locator 210 for identifying a relative location of devices in an area, and a controller 212 for identifying a sound capability of devices based on the relative location and the room acoustics. In one aspect, the device locator 210 can employ principles of triangulation based on received signal strength for determining a relative location of the device, but is not so limited. The device locator 210 may also include global positioning system (GPS) for identifying a location of the device. Other suitable location technologies can also be employed for determining a position or a relative location. The controller 212 can also determines whether a device is fixed (i.e. non-mobile) or mobile, and determine when devices enter or leave an area, such as a room.

The mobile device 104 can also include a processor 214 for formatting audio media based on the sound capability, and adjusting a delivery of audio to the devices in accordance with the relative location. The processor can render sound in various audio formats such as Dolby Digital™, Stereo, Digital Theater Service™ (DTS), Digital Video Data (DVD) audio, or any other suitable surround sound audio format. A sound capability can identify an audio bandwidth, a data processing capacity, a power level, a battery capacity, or a speaker volume level. A sound capability can also identify a mobility, a processing overhead, or a resource use of the mobile device. For example, a mobile device may be traveling through an area and available only temporarily. A mobile device may be processing various applications and unable to receive audio media for generating surround sound. Accordingly, knowledge of the sound capability assists a master device assign audio channels to the slave devices. Accordingly, the processor 214 can assess a sound capability of the mobile device 104 and report the sound capability to a master device.

The mobile device can play a portion of an audio media out of the speaker 201 for generating sound 105 (See FIG. 1). The mobile device 104 can also include a sound analyzer 216 for analyzing room acoustics and the surround sound generated by the devices, and reporting the room acoustics and a feedback quality of the surround sound to the master device. As an example, the sound analyzer can assess a quality of surround sound by listening to sound captured at the microphone 202. A master device can then determine which devices should be used to generate surround sound, and which devices should analyze a quality of the surround sound.

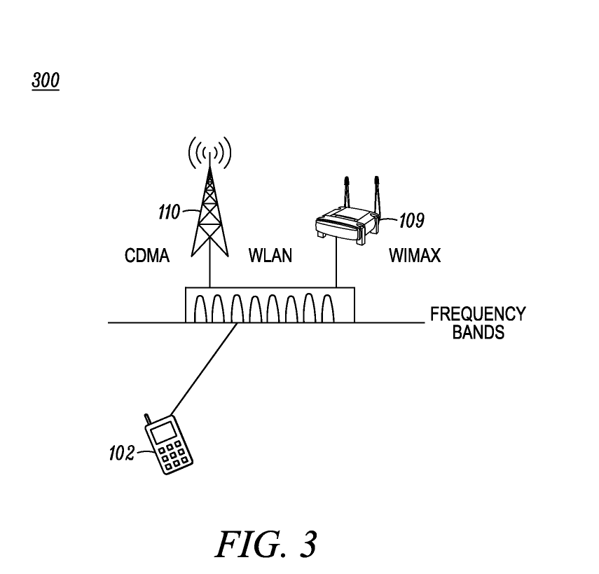

Referring to FIG. 3, a mobile communication system 100 for sharing an audio experience is shown. The mobile communication system 100 can provide wireless connectivity over a radio frequency (RF) communication network such as a base station 110. The base station 110 may also be a base receiver, a central office, a network server, or any other suitable communication device or system for communicating with the one or more mobile devices. The mobile device 104 can communicate with one or more cellular towers 110 using a standard communication protocol such as Time Division Multiple Access (TDMA), Global Systems Mobile (GSM), integrated Dispatch Enhanced Network (iDEN), Code Division Multiple Access (CDMA), Orthogonal Frequency Division Multiplexing (OFDM) or any other suitable modulation protocol. The base station 110 can be part of a cellular infrastructure or a radio infrastructure containing standard telecommunication equipment as is known in the art.

In another arrangement, the mobile device 104 may also communicate over a wireless local area network (WLAN). For example the mobile device 102 may communicate with a router 109, or an access point, for providing packet data communication. In a typical WLAN implementation, the physical layer can use a variety of technologies such as 802.11b or 802.11g Wireless Local Area Network (WLAN) technologies. As an example, the physical layer may use infrared, frequency hopping spread spectrum in the 2.4 GHz Band, or direct sequence spread spectrum in the 2.4 GHz Band, or any other suitable communication technology.

The mobile device 102 can receive communication signals from either the base station 110 or the router 109. In one arrangement, the master device 102 (See FIG.1) can send communication signals to the slave devices in the mobile communication system for synchronizing a delivery of audio. For example, each of the slave devices 104 (See FIG. 1) can be assigned an audio channel to play one portion of an audio media. The master device can transmit communication signals over the mobile communication environment to coordinate the delivery of the audio media. Other telecommunication equipment can be used for providing communication and embodiments of the invention are not limited to only those components shown. As one example, the mobile device 102 may receive a UHF radio signal having a carrier frequency of 600 MHz, a GSM communication signal having a carrier frequency of 900 MHz, or an IEEE-802.11x WLAN signal having a carrier frequency of 2.4 GHz.

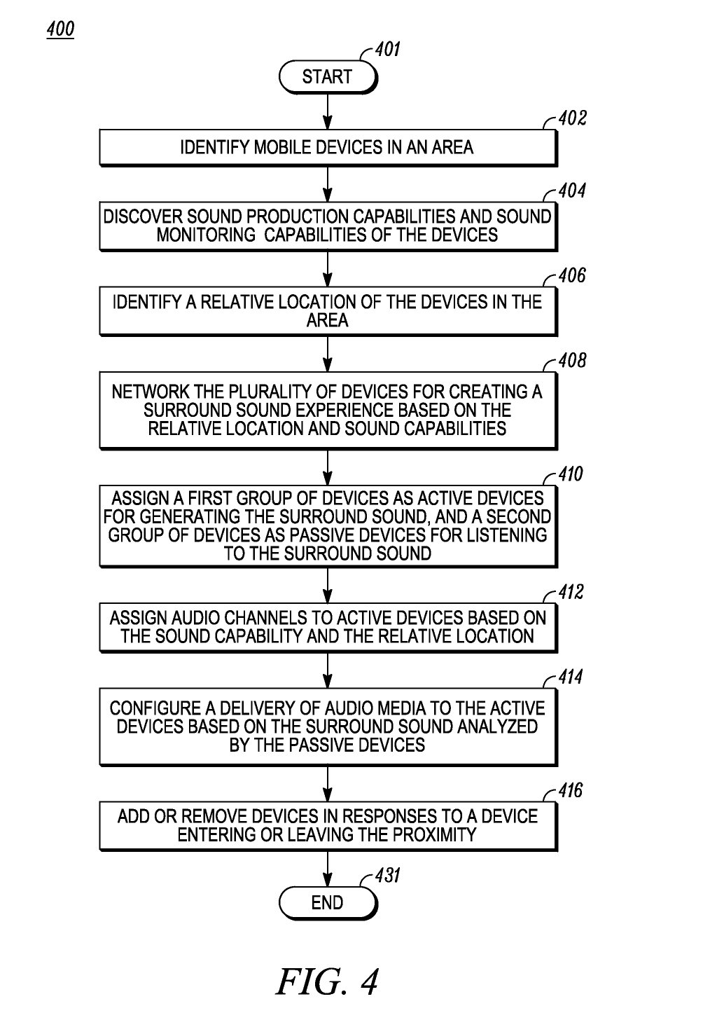

Referring to FIG. 4, a method 400 for sharing an audio experience is shown. The method 400 can be practiced with more or less than the number of steps shown. To describe the method 400, reference will be made to FIGS. 1, 2, 3, and 5 although it is understood that the method 400 can be implemented in any other suitable device or system using other suitable components. Moreover, the method 400 is not limited to the order in which the steps are listed in the method 400. In addition, the method 400 can contain a greater or a fewer number of steps than those shown in FIG. 4.

At step 401, the method 400 can start. The method 400 can start in a state wherein a plurality of users each having one or more mobile devices 104 (See FIG. 1) assemble together in an area, such as a room. The mobile devices may each support capabilities for producing sound. For example, referring back to FIG. 2, the mobile devices 104 may include a speaker 201 for playing a portion of audio, such as a sound clip, or an MP3. The processor 214 of the mobile device 104 may also be configured to receive an audio stream to play a portion of audio media. It should be noted that the mobile devices 102 are individually capable of producing sound, such as playing music. As a collective group, the devices can emulate a surround sound system in accordance with the method 400. That is, the devices 104 can be combined together to provide a coordinated delivery of audio to produce a surround sound experience.

Briefly, each mobile device 104 can be generate a portion of audio that contributes to an overall audio experience. One of the mobile devices can be assigned as a master device 102 (See FIG. 1). For example, a user having a mobile device may initiate, or launch, a mobile disc jockey (DJ) session. The mobile device launching the session can be the master device 102. In one arrangement, the session can be a mobile (Disc Jockey) DJ application which allows users to share a music experience. In another arrangement, the master device can delegate audio delivery to a non-mobile device. For example, if the master device is in a room with a home stereo capable of providing stereo surround sound, the master device can coordinate with the home stereo for providing surround sound.

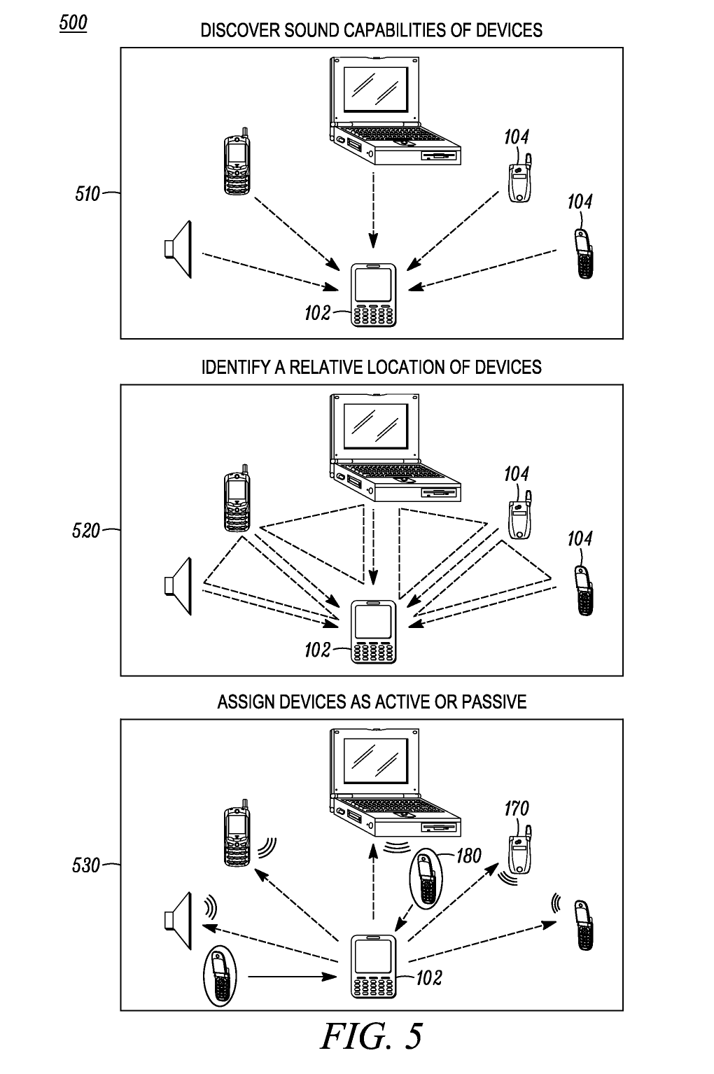

At step 402, mobile devices in an area can be identified. For example, the master device 102 can send an invite to devices within a local area. Devices within the local area can respond to the invite and identify themselves. At step 404, sound production capabilities and sound monitoring capabilities of the devices can be identified. For example, each of the devices responding to the invite can submit device sound capability information. A device may identify itself as having stereo sound capabilities, a high-audio speaker, an audio bandwidth, a data capacity rate for receiving or processing audio, or a battery capacity. In practice, referring to FIG. 5, at step 510, slave devices 104 can communicate sound capabilities to the master device 102 via various communication schemes as discussed previously in FIG. 3.

At step 406, a relative location of the devices in the area can be identified. For example, the device locator 210 (See FIG. 2) of the mobile device 104, can determine a relative location of the devices. Notably, a relative location identifies distances relative to the devices. That is, the device locator 210 identifies a location of the immediate device relative to a location of other devices 104. In one arrangement, the device locator 210 can employ triangulation techniques based on a relative signal strength of devices in the local area. For example, as discussed in FIG. 3, the devices 104 may be in a WLAN ad-hoc network communicating. A signal strength of the WLAN communication signals can be measured to identify a relative location using principles of triangulation. For example, referring to FIG. 5, at step 520, each device can assess communications signals received from devices in the ad-hoc group to determine a relative location. Notably, the devices can send their relative location to the master device 102, which can assess the relative location of all the devices 104 in the ad-hoc network.

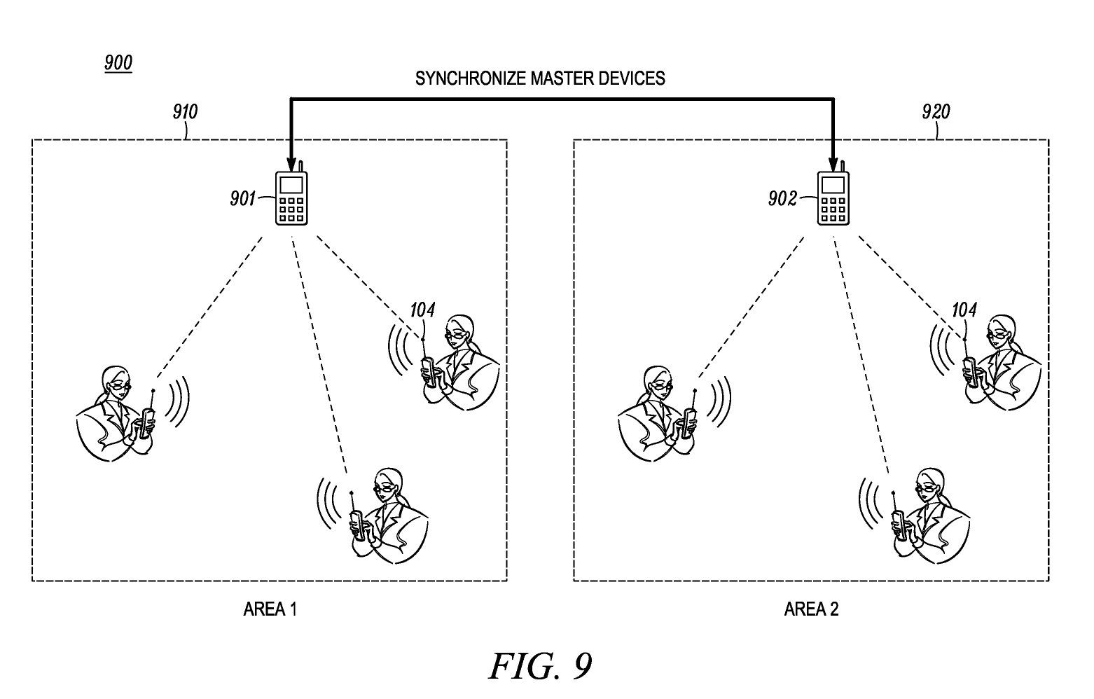

At step 408, the plurality of devices can be networked for creating a surround sound experience based on the relative location. For example, the master device 102 and the slave devices 104 can be networked over a RF communication link 110 or a WLAN communication link 109 as discussed in FIG. 9. The master device 102 and the slave devices 104 can also be networked together over a short range communication such as Bluetooth or ZigBee but are not herein limited to these. Bluetooth and ZigBee communication can also be employed to stream audio between slave devices 104 for generating the surround sound.

At step 410, devices can be assigned as an active device or as a passive device based on their relative location and sound capability. For example, referring to FIG. 5, at step 530, the master device can assign a first group of devices as active devices 170 for generating the surround sound, and a second group of devices as passive devices 180 for listening to the surround sound. It should be noted that active devices 170 produce sound, and passive devices 180 listen to the sound generated by the active devices. The passive devices 180 can assess a sound quality and report the sound quality to the master device 102 as feedback. The master device 102 can adjust a delivery of audio the active devices 180 based on the sound quality feedback from the passive devices 180.

At step 412, audio channels can be assigned to active devices based on the sound capability and relative location. For example, the master device 102 can assign one or more audio channels to the slave devices 104 based on a location of the slave devices 104. Slave devices 104 to a left of the master device 102 can be assigned a left audio channel, and slave devices to the right of the master device 102 can be assigned a right audio channel. The master device 102 can further assign audio channels based on a bandwidth, battery capacity, or high-audio speaker capabilities in addition to the relative location. For example, high-audio speakers can be assigned low frequency audio, and devices with small speakers and wide audio bandwidths can be assigned mid-range or high frequency audio. The master device 102 can synchronize the delivery of audio based on the relative location. The master device 102 can determine that devices farther away may introduce a delay in the audio signal. Accordingly, the master device can synchronize the delivery of audio to the slave devices 104 to account for time delays in the generation of the audio based on the relative location and sound capability of the devices.

At step 414, a delivery of audio media to the active devices can be configured based on the surround sound analyzed by the passive devices. For example, referring to FIG. 5, at step 530, the master device 102 can receive feedback regarding the quality of sound produced by the active devices 170. The master device can adjust the delivery of audio to the devices based on the sound quality. The sound quality may include aspects of volume, balance, equalization, and reproduction quality.

At step 416, devices can be added or removed in response to a device entering or leaving a proximity. Methods of determining transceiver location relative to other transceivers will be known to those skilled in the art, and may include comparing signal strength of received signals, time of arrival of received signals, or angle of arrival of received signals, as well as other techniques. For example, referring to FIG. 5, one or more devices may enter or leave the room. Active devices leaving the room will no longer be able to contribute to the surround sound and the shared music experience. Accordingly, the master device 102 can assign new devices entering the room, or passive devices already in the room, as active devices. Similarly, as new devices enter the room, the master device 102 can assign them as active or passive devices based on their relative location and a feedback quality from passive devices. At step 431, the method 400 can end.

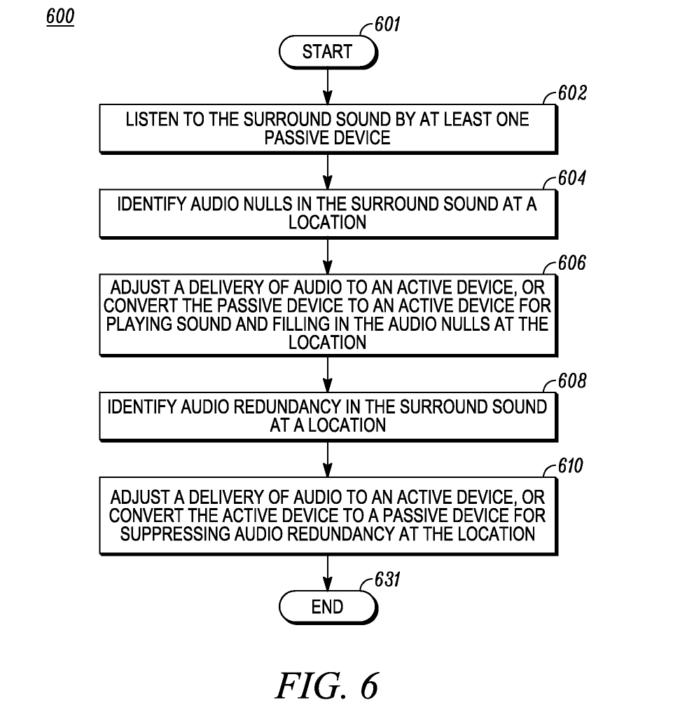

Briefly, referring to FIG. 6, a method 600 for assessing sound quality is shown. Notably, the method 600 provides one embodiment of method step 414 of FIG. 4 for configuring a delivery of audio media. At 601, the method can start. At 602, At least one passive device can listen to the surround sound. For example, the sound analyzer 216 of a passive device 104 (See FIG. 2) can assess a sound quality of the surround sound. The sound analyzer 216 can receive the surround sound from the microphone 202 and perform a spectral analysis or other suitable form of analysis for assessing a quality of the sound. At step 604, audio nulls in the surround sound can be identified at a location. For example, referring to FIG. 5, the location of the devices 104 can affect the sound quality produced. Audio nulls can correspond to locations wherein insufficient sound is being produced. Accordingly, at step 606, a delivery of audio can be adjusted to the active devices, or the passive device can be converted to an active device for playing sound and filling in the audio nulls at the location. For instance, the master device 102 can receive the feedback from the slave devices identifying the locations of the audio nulls. The master device 102 can identify a passive device 180 at a location closest to the audio null, and convert the passive device 180 to an active device 170. The master device 102 can deliver audio to the now active device 170 to generate sound and fill in the audio null.

Similarly, at step 608, audio redundancy in the surround sound can be identified at a location. Audio redundancy can correspond to locations where excessive sound is being produced. Audio redundancy can adversely change the balance of the volume or equalization thereby leading to low audio quality. This can adversely affect the shared music experience. Notably, the passive devices 180 analyzing the surround sound can report audio redundancy to the master device 102. Accordingly, at step 610, a delivery of audio to an active device can be adjusted, or the active device can be converted to a passive device for suppressing audio redundancy at the location. At step 631, the method 600 can end.

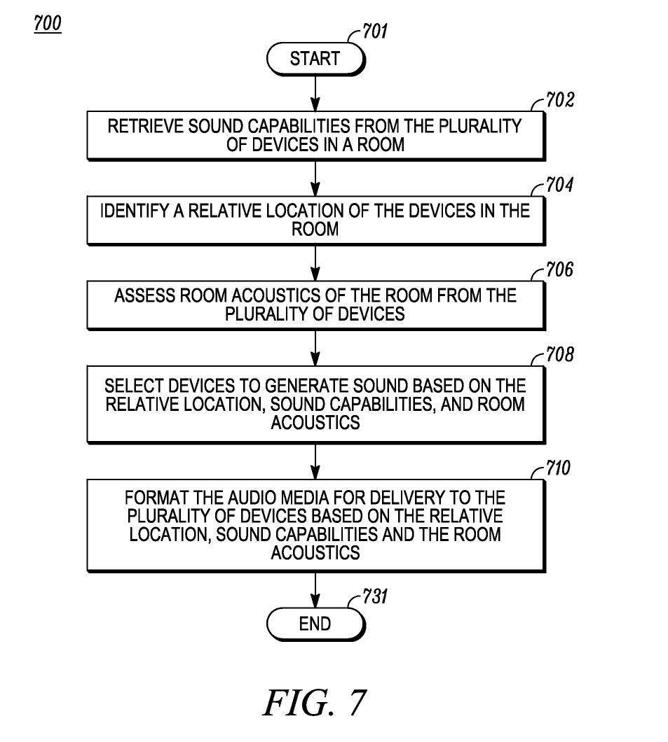

Referring to FIG. 7, a method 700 for configuring a delivery of audio is shown. The method 700 can be an extension to method 400 for sharing an audio experience or can be included as part of the method 400. In particular, the method 700 assess room acoustics for configuring a delivery of audio. The method 700 can be practiced with more or less than the number of steps shown. To describe the method 700, reference will be made to FIGS. 1, 2, 3, and 5 although it is understood that the method 700 can be implemented in any other suitable device or system using other suitable components. Moreover, the method 700 is not limited to the order in which the steps are listed in the method 700. In addition, the method 700 can contain a greater or a fewer number of steps than those shown in FIG. 7.

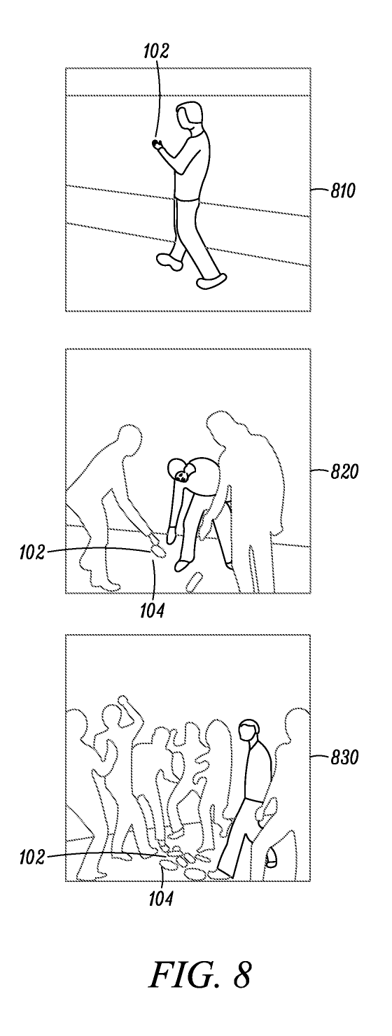

At step 701, the method can start. The method can start in a state wherein a user launches a mobile Disc Jockey (DJ) session. For example, referring to the illustration of FIG. 8, at step 810, a user can identify a song on a mobile device to play. Upon commencing the mobile DJ session the mobile device becomes a master device 102. The user may have the song downloaded on the master device 102, or the user may download the song to the master device 102. At step 820, the user may enter a room where a plurality of users have devices 104 capable of joining the mobile DJ session. The plurality of devices are slave devices 104 with respect to the master device since the master device launched the mobile DJ session.

Returning back to FIG. 7, at step 702, sound capabilities can be retrieved from the plurality of devices in a room. At step 704, a relative location of the devices in the room can be determined. A sound capability can identify an audio bandwidth, a data processing capacity, a power level, a battery capacity, or a speaker volume level as discussed in FIG. 2. Referring again to the illustration of FIG. 8, the master device 102 can query the slave devices 104 for sound capabilities and for their location as discussed in method 400 of FIG. 4. At step 706, room acoustics can be assessed from the plurality of slave devices 104. For example, referring back to FIG. 2, the sound analyzer 216 can assess the acoustics of the room.

The room acoustics identify the changes in sound due to an arrangement of the room and objects in the room. The room acoustics can be characterized by an amplitude, phase, and frequency of a transfer function as is known in the art. The transfer function identifies how the quality of sound may change. For example, objects in the room may have strong absorptive properties or reflective properties. An acoustic sound wave generated by a speaker may reflect off objects in the room, thereby changing the perception of the sound wave. For example, sound may be dampened or enhanced based on the properties of objects in the room. Notably, a sound analyzer 216 of a passive device assess the room acoustics and reports the room acoustics to the master device. Recall in FIG. 5, the passive devices 170 can listen to the surround sound and report a quality of the surround sound as feedback to the master device 102. Similarly, the passive devices 170 can listen for reverberations in the room to assess the room acoustics and report this information to the master device 102. For example, referring to FIG. 8, at step 820, the master device 102 can assess the relative location of slave devices 104, assess sound capabilities of the slave devices 104, and assess the room acoustics.

Returning back to FIG. 7, at step 708, audio devices can be selected to generate sound based on the relative location of the devices, the sound capabilities of the devices, and the room acoustics. For example, referring to FIG. 5, the master device 102 identifies a relative location of the plurality of slave devices 104, classifies devices as active 170 or passive 180 based on a relative location of the devices, assigns an audio channel to active devices to produce a portion of the surround sound, and coordinates a delivery of audio media to the group of active devices based on the relative location and feedback quality from the passive devices. Notably, devices can be assigned as active devices or passive devices based on their sound capabilities and location with respect to the room acoustics. For example, a low-audio speakerphone may not produce a loud sound compared to a high-audio speakerphone when placed at a common location. However, a low-audio speakerphone in a location corresponding to high reverberation and echo may produce a loud sound. Similarly, a high-audio speakerphone in an isolated area having sound absorptive properties may produce a muffled sound. Accordingly, the master device 102 can assess the sound capabilities and locations of the slave devices for determining which devices should actively contribute to the surround sound. Notably, the master device 102 assigns certain slave devices as active for generating sound, and certain slave devices as passive devices for listening to the surround sound produced by the active devices.

At step 710, audio media can be formatted for delivery to the plurality of devices based on the relative location, the sound capabilities and the room acoustics. Formatting can include assigning audio channels to one or more active devices for playing a portion of an audio media to generate a surround sound. Recall, at step 708, the master device 102 assigned slave devices as active devices. For example, referring to FIG. 8, the master device 102 can identify a position of active devices in the room, assign audio channels to the active devices based on the position, monitor the active devices contributing to the surround sound, and update a delivery of audio in accordance with sound capabilities of the active devices for maintaining a quality of the surround sound.

For instance, the passive devices 180 (See FIG. 5) can analyze the surround sound by evaluating a volume level of the surround sound, and reporting the volume level to the master device 102. The master device 102 can equalize the volume level across the plurality of devices, such that a volume of the surround sound is balanced in accordance with a specification of the audio media. As another example, the passive devices can analyze the surround sound by evaluating a stereo distribution of the surround sound, and reporting the stereo distribution to the master device. The master device can equalize the stereo distribution across the plurality of devices, such that a stereo effect of the surround sound is distributed in accordance with a specification of the audio media.

In another arrangement, a first plurality of devices in a first area can share an audio experience with a second plurality of devices in a second area. For example, referring to FIG. 9, a first master device 901 that generates a surround sound from a plurality of slave devices 104 in a first area 910 can synchronize with a second master device 902 to generate a surround from a plurality of slave devices 104 in the second area 910. Notably, the devices in the first area 910 may be in a different location and with differing relative locations than the devices in the second area 920. Accordingly, the first master device 910 and the second master device 902 synchronize the delivery of audio such that a timing of the surround sound delivery is the same. That is, the users in the first area 910 hear the surround sound at the same time users in the second area 920 hear the surround sound. This allows users to share the same sound experience at a similar time.

As users enter or leave the area 910, the master devices 901 and 902 can also assign slave devices as active or passive. In one arrangement, users in the first area 910 and the second area 920 can share music together. For example, a first user of the first area 910 may request the master device 901 to play a song to the users in the first area 910 and the second area 920. The first master device 901 can synchronize with the second master device 902 to share the music. The master device 901 can send a music file to the second master device to share with the second users in the second area 920. In certain cases, the master device (901 or 902) or the slave devices 104 may stream audio off the internet. The master device can assess the sound capabilities of the slave devices to determine bandwidth capacity. If the bandwidth does not allow live streaming, a master device can send music files off line and synchronize with other master devices for coordinating the delivery of audio. For example, master device 901 may send a music file to the master device 902. When the master device 902 is ready, master device 901 can send start and stop commands to synchronize a delivery of audio to the slave devices 104. Such an arrangement allows mobile device users to share an audio experience.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not limited. Numerous modifications, changes, variations, substitutions and equivalents will occur to those skilled in the art without departing from the spirit and scope of the present embodiments of the invention as defined by the appended claims.

What is claimed is:

1. A method for sharing an audio experience, comprising:
networking a plurality of devices that are in proximity of one another;
identifying a relative location of the plurality of devices in the proximity;
configuring a delivery of audio media to the plurality of devices based on the relative location, and device capabilities; and
generating a surround sound from the plurality of devices in accordance with the delivery of audio,
wherein a master device assigns a first group of devices as active devices for generating the surround sound, and a second group of devices as passive devices for listening to the surround sound, and the master device configures the delivery of audio media to the active devices based on the surround sound analyzed by the passive devices.

2. The method of claim 1, wherein the networking further comprises:
discovering sound capabilities for the plurality of devices, wherein the sound capability identifies an audio bandwidth, a data processing capacity, a battery capacity, a speaker volume level, a mobility, or available resources.

3. The method of claim 2, wherein the configuring further comprises:
assigning audio channels to active devices based on the sound capability and the relative location; and
adding or removing devices in responses to a device entering or leaving the proximity.

4. The method of claim 1, wherein configuring a delivery of audio media further comprises:
listening to the surround sound by at least one passive device:
identifying audio nulls in the surround sound at a location; and
adjusting a delivery of audio to an active device, or converting a passive device to an active device for playing sound and filling in the audio nulls at the location.

5. The method of claim 1, wherein configuring a delivery of audio media further comprises:
listening to the surround sound by at least one passive device;
identifying audio redundancy in the surround sound at a location; and
adjust a delivery of audio to an active device, or converting an active device to a passive device for suppressing audio redundancy at the location.

6. The method of claim 1, wherein configuring a delivery of audio further comprises:
retrieving sound capabilities from the plurality of devices in a room;
assessing room acoustics of the room from the plurality of devices;
selecting devices to generate sound based on the sound capabilities; and
formatting the audio media for delivery to the plurality of devices based on the relative location, the sound capabilities and the room acoustics.

7. The method of claim 6, further comprising:
identifying a position of active devices in the room;
assigning audio channels to the active devices based on the position;
monitoring the active devices contributing to the surround sound;
updating a delivery of audio in accordance with sound capabilities of the active devices for maintaining a quality of the surround sound.

8. The method of claim 6, further comprising:
synchronizing the sound experience with another plurality of devices in another area.

9. The method of claim 1, wherein the passive devices analyze the surround sound by:
evaluating a volume level of the surround sound; and
reporting the volume level to the master device, wherein the master device equalizes the volume level across the plurality of devices, such that a volume of the surround sound is balanced in accordance with a specification of the audio media.

10. The method of claim 1, wherein the passive devices analyze the surround sound by:
evaluating a stereo distribution of the surround sound; and
reporting the stereo distribution to the master device, wherein the master device equalizes the stereo distribution across the plurality of devices, such that a stereo effect of the surround sound is distributed in accordance with a specification of the audio media.

11. A system for mobile disc jockey (DJ), comprising:
a plurality of devices for generating and monitoring a surround sound in an area; and
a master device for assigning devices as active devices or passive devices based on a relative location of the devices and a feedback quality of the surround sound,
wherein the master devices coordinates a delivery of audio to the plurality of devices for sharing an audio experience.

12. The system of claim 11, wherein the plurality of devices comprise:
a group of active devices in an area for generating the surround sound;
a group of listening devices in the area for listening to the surround sound, assessing room acoustics, and reporting a feedback quality of the surround sound,
wherein the master device identifies a relative location of the plurality of devices, classifies devices as active or passive based on a relative location of the devices, assigns an audio channel to active devices to produce a portion of the surround sound, and coordinates a delivery of audio media to the group of active devices based on the relative location and feedback quality from the passive devices.
wherein an active device, a listening device, and the master device perform interchangeable functions, such that an active device or passive can be configured as a active device or passive device and that can also be configured as a master device.

13. The system of claim 11, wherein a device comprises:
a device locator for:
identifying a relative location of active devices and listening devices in the area;
a controller for:
identifying a sound capability of an active device or listening device based on the relative location, and
a processor for:
formatting audio media based on the sound capability; and
adjusting a delivery of audio to the group of active devices in accordance with the relative location and a feedback quality from the group of listening devices,
wherein the sound capability identifies an audio bandwidth, a data processing capacity, or a speaker volume level.

14. The system of claim 11, wherein the controller further
determines whether a device is fixed or mobile; and
determines when devices enter or leave the area.

15. The system of claim 11, wherein a device further includes:
a sound analyzer for analyzing room acoustics and the surround sound generated by the group of active devices, and reporting the room acoustics and a feedback quality of the surround sound to the master device.

16. The system of claim 12, wherein the processor:
assigns one of the mobile devices as an active device or as a listening device based on the relative location; and
configures a delivery of audio media to the active device by specifying a sound channel,
wherein the delivery of audio includes streaming audio from the master to the active devices or downloading audio to the active devices

17. The system of claim 12, wherein the master device:
synchronizes the sound delivery with a second system.

18. A method for sharing an audio experience comprising:
identifying mobile devices in an area;
identifying a relative location of the devices in the area;
discovering sound production capabilities and sound monitoring capabilities of the devices;
sending an invite to the devices for launching a mobile (Disc Jockey) application; and
networking the plurality of devices for creating a surround sound experience based on the relative location.

19. The method of claim 18, further comprising:
assigning a first group of devices as active devices for generating the surround sound,
assigning a second group of devices as passive devices for listening to the surround sound, and
configuring a delivery of audio media to the active devices based on a relative location of the active devices and a feedback quality of the surround sound from the passive devices.

20. The method of claim 19, wherein the identifying a relative location of the devices includes:
triangulating a location of a device based on relative signal strength.
